(19) United States
(12) Patent Application Publication
(10) Pub. No.: US 2010/0262624 A1
(43) Pub. Date: Oct. 14, 2010

(54) DISCOVERY OF INACCESSIBLE COMPUTER RESOURCES

(75) Inventor: Jack M. Pullikottil, Bothell, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/423,023

(22) Filed: Apr. 14, 2009

(51) Int. Cl. G06F 17/30

(52) U.S. Cl. 707/783; 707/E17.108; 707/E17.055

(57) ABSTRACT

A request for a search of computer resources can be received at a search engine. The search of the resources can be conducted, and search results can be produced. The search results can include an accessible resources set, which includes one or more representations of one or more resources to which an object associated with the request has access. The search results can also include a discoverable resources set, which includes one or more representations of one or more resources to which the object does not have access, but does have permission to request access. Additionally, the search results can include a set of one or more identifiers that distinguish between the accessible resources set and the discoverable resources set.

### BACKGROUND

Organizations sometimes rely on search engines to enable users to find information from access controlled computer resources. As used herein, the terms computer resource(s) or simply resource(s) refer broadly to one or more computer information resources that can be discovered in some way, such as by conducting a computer search or browsing a computer directory. A few examples of computer resources include directories, websites, mailing lists, discussion forums, and subscription feeds. In large organizations, when placing restrictions on an access-controlled resource, it is a typical practice to deny access to everyone except users who have been identified explicitly or who meet an explicitly defined set of conditions. When such organizations allow users to invoke search engines to search the access-controlled resources, the search engines typically only return results for accessible resources, i.e., resources to which a pertinent object (such as a user object corresponding to a user who invoked the search) currently has access. In that way, such search systems are able to keep unauthorized users from accessing or even knowing about inaccessible resources, i.e., resources to which a pertinent object (such as a user object corresponding to a user who invoked the search) currently does not have access.

### SUMMARY

Whatever the advantages of previous tools and techniques for the discovery of access controlled resources, they have neither recognized the inaccessible computer resource discovery tools and techniques described and claimed herein, nor the advantages produced by such tools and techniques.

In one embodiment of the tools and techniques, user input associated with a user object and requesting a search of resources in one or more computer databases can be received at a search portal from an input device. A request to perform the search of the resources can be sent to a search engine, and search results can be received from the search engine in response to the request. At least a portion of the search results from the search of the resources can be displayed on a computer display. The displayed search results can include one or more representations of one or more resources to which the user object currently has access, and one or more representations of one or more resources to which the user object does not currently have access.

In another embodiment of the tools and techniques, a network data structure that represents a network of objects, and an access control data structure that indicates a set of computer resources that a user has permission to access, can be generated. The access control data structure can be used to identify one or more user-accessible computer resources in the set of computer resources. The one or more accessible computer resources can be one or more resources that an object or user is able to access. The network data structure can be used to identify one or more computer resources to which the object does not have access, but to which the object can request access.

In yet another embodiment of the tools and techniques, a request for a search of computer resources can be received at a search engine. The search of the resources can be conducted, and search results can be produced. The search results can indicate accessible resources, including one or more representations of resources to which an object associated with the request has access. The search results can also include a discoverable resources set, including one or more representations of resources that the object is not presently allowed to access, but can request permission to access. Additionally, the search results can indicate which resources are accessible and which resources are discoverable.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is a schematic diagram of an inaccessible resource discovery system.

FIG. 3 is a diagram of a search portal display area.

FIG. 4 is a flow diagram of an inaccessible computer resource discovery technique.

FIG. 5 is a flow diagram of a technique for producing search results with discoverable resource suggestions.

FIG. 6 is a flow diagram of a technique for displaying search results with inaccessible resources.

FIG. 7 is a flow diagram of a technique for discovering and requesting access to inaccessible resources.

### DETAILED DESCRIPTION

Described embodiments are directed to techniques and tools for improved discovery of inaccessible computer resources. Such improvements may result from the use of various techniques and tools separately or in combination.

As noted above, in large organizations, when placing restrictions on an access-controlled resource, it is a typical practice to deny access to everyone except users who have been identified explicitly or who meet an explicitly defined set of conditions. Over time, this can result in a situation where the initially defined set of conditions may no longer accurately reflect the intended access policy, or the access policy itself may be in need of updating. Additionally, the resource's existence may not be adequately published to newcomers, and the resource owners may not keep track of changes to users who should have access to the resource or their roles in the organization. In any case, over time, more and more users who should be getting access to the resource often are not getting such access, and many users may not even be aware of the existence of the resource. In such a situation, existing “access-aware” search engines can be inadequate for discovering resources, as only people who have access to the resources will get results from them.

Accordingly, one or more substantial benefits can be realized from the inaccessible resource discovery tools and techniques described herein. For example, some users who do not currently have access to resources can be made aware of the existence of the resources. Such users can be given an option to request access to the resources. For example, this could be done by applying rules to network data structures that define relationships between user objects. Network data structures are data structures that define relationships between different objects, such as user objects associated with one or more users. The network data structures need not be discrete files or objects themselves, although they may be. For example, a network data structure may be in the form of neighbor list attributes on objects such as user objects. Such data structures can be limited according to rules to control which user objects (and accordingly which corresponding users) are able to be made aware of access-controlled resources.

As an example, a user can initiate a user-defined search that is associated with a user object corresponding to the user, such as can occur where a user is logged into a user account. The search can be a search of access controlled resources, and the user can be presented with representations of resources to which the user has access, and that are within the scope of the search. The user can also be presented with suggestions of discoverable resources to which the user does not have access but can request such access. The suggestions can be representations of the resources, and the suggestions may present a user with options to request access to the corresponding resources. Another example is a push or subscription model where a user may have signed up for a search enabled aggregation service. The service can aggregate results from multiple feeds (RSS, Atom, etc.), based on search criteria, and can compose the results into a single feed to which the user can subscribe using a suitable client and/or by opting to receive periodic emails. In this model, the email and/or the aggregated feed can contain summaries and links to accessible resources, as well as links to discoverable resources.

Accordingly, users can gain an enhanced ability to discover inaccessible resources that the users should be able to access, and to request access to such resources.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Techniques described herein with reference to flowcharts may be used with one or more of the systems described herein and/or with one or more other systems. Moreover, for the sake of simplicity, flowcharts may not show the various ways in which particular techniques can be used in conjunction with other techniques.

### I. Exemplary Computing Environment

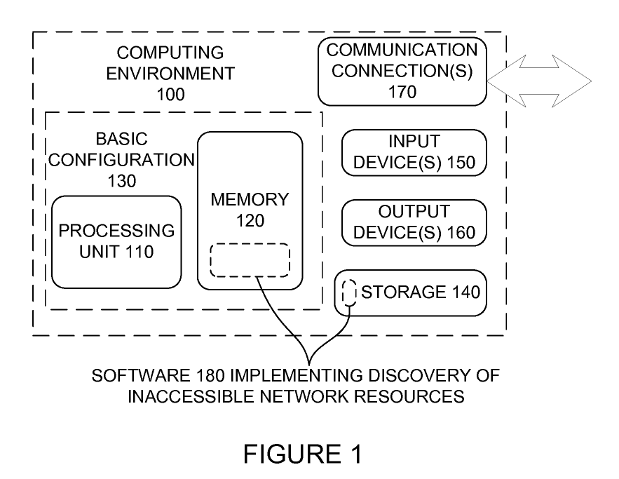

FIG. 1 illustrates a generalized example of a suitable computing environment (100) in which one or more of the described embodiments may be implemented. For example, one or more such computing environments can be used as a system for discovery of inaccessible resources. Generally, various different general purpose or special purpose computing system configurations can be used. Examples of well-known computing system configurations that may be suitable for use with the tools and techniques described herein include, but are not limited to, server farms and server clusters, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, the computing environment (100) includes at least one processing unit (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing discovery of inaccessible resources.

Although the various blocks of FIG. 1 are shown with lines for the sake of clarity, in reality, delineating various components is not so clear and, metaphorically, the lines would more accurately be grey and fuzzy in FIG. 1 and the other figures below. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include computer readable storage media such as magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be a touch input device such as a keyboard, mouse, pen, or trackball; a voice input device; a scanning device; a network adapter; a CD/DVD reader; or another device that provides input to the computing environment (100). The output device(s) (160) may be a display, printer, speaker, CD/DVD-writer, network adapter, or another device that provides output from the computing environment (100).

The communication connection(s) (170) enable communication over a communication medium to another computing entity. Thus, the computing environment (100) may operate in a networked environment using logical connections to one or more remote computing devices, such as a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media. Computer-readable media are any available media that can be accessed within a computing environment. By way of example, and not limitation, with the computing environment (100), computer-readable media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “determine,” “choose,” “send,” “receive,” “generate,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Inaccessible Resource Discovery System and Environment

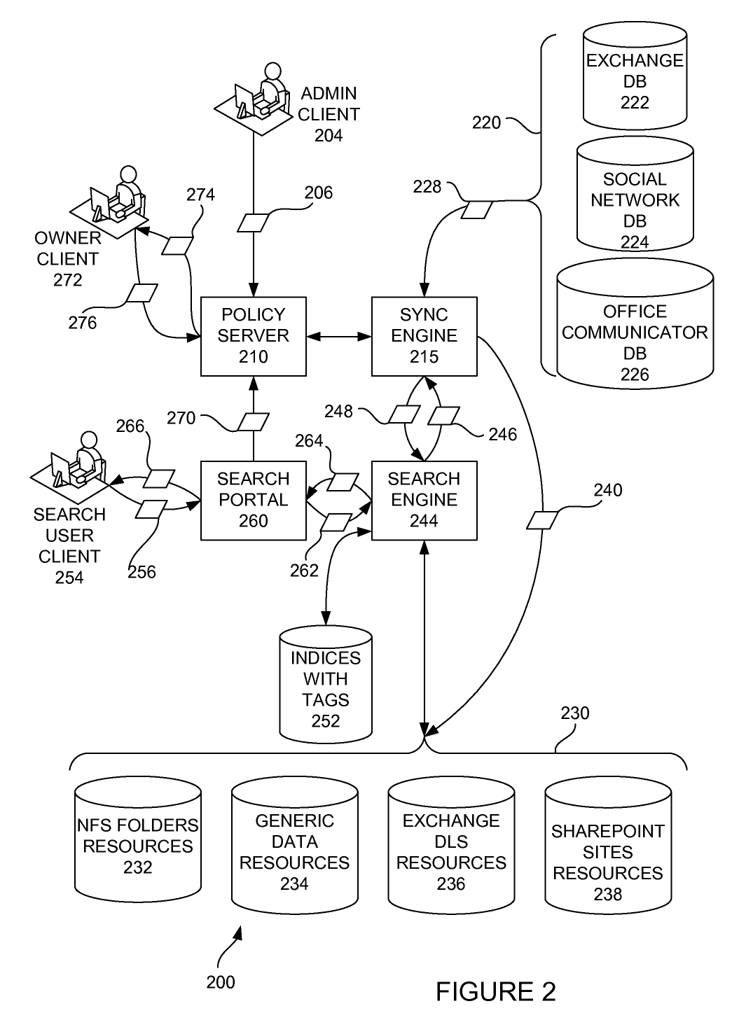

Referring to FIG. 2, an inaccessible resource discovery system (200) will be described.

A. Administrator Client and Policy Server

The system (200) can include an administrator client (204), which can be a computing environment such as the computing environment (100) discussed above. The administrator client (204) can provide administrator user input information (206) to a policy server (210).

The policy server (210) can be a policy server module, such as a policy server module of ILM 2. The policy server (210) can define network data structures; workflows for creating, modifying, or deleting data structures, such as objects and attributes that define the network data structure; workflows that define processes for requesting and gaining access (i.e., gaining access rights) to resources; and access control rules and access control lists (which can be various different types of data structures) that define the access rights themselves (e.g., what permissions an object has, such as read or write permissions). For example, the policy server (210) can be a policy server of Microsoft's Identity Lifecycle Manager “2” (ILM 2) identity management software.

In ILM 2, workflows can be used to manage objects and attributes associated with the objects. For example, authentication workflows can define processes to determine the identity of a requestor; authorization workflows can define processes to determine whether or not someone or something is allowed to do something (including requesting and gaining access to a specific object); and action workflows can carry out an action (e.g., create, modify, and delete) on the behalf of something and on something (such as modifying or deleting something on behalf of a user object). The creation, modification, or deletion of objects (such as user objects or resource objects) can kick off a workflow if the workflow is specified by a management policy rule. Accordingly, in ILM 2, workflows can be used to update network data structures. For example, when a new user object is created, a management policy rule can specify that an action workflow will initiate to update a neighbor attribute of the new user object after computing who the neighbors are. One or more management policy rules could also specify that additional workflows will initiate to update neighbor attributes of other objects to refer to the newly-created user object.

In defining network data structures, the policy server (210) can utilize relationships between objects to build the network data structures so that the network data structures represent those relationships between the objects. For example, if the policy server (210) finds that two user objects are linked as friends in a social networking system or have each other listed as contacts in a Microsoft Exchange or Microsoft Office Communicator system, the policy server (210) can link representations of those objects in the network data structure, so long as such links do not violate management policy rules, which are discussed below.

The administrator user input information (206) can include information to be used by the policy server (210) for identity and resource access management. For example, the administrator user input information (206) can include information to define object types, sets, management policy rules, and workflows.

Object types can be any of a variety of object types, such as user objects, which correspond to users and may define user attribute and profile information (name, contact information, groups of which the user is a member, etc.). Access rights can be associated with such objects. For example, a particular user object may be granted access rights to a particular resource. This may be indicated as an attribute of the user object, or more commonly an attribute of the resource or representations of the resource Sets can be sets of objects (users, groups, resources, etc.) having dynamic membership based on filters, which can be defined by rules that can be in a language that is useable by the policy server (210). Policy rules, which are discussed more below, can be written to apply to particular sets of objects.

Workflows defined by the administrator user input information (206) can include workflows that define processes for requesting and obtaining access (i.e., requesting and obtaining access rights) to resources, and workflows for creating, modifying and deleting object network data structures and discovery lists. Discovery lists are data structures, which can be in various formats, that indicate which resources are discoverable for which objects.

The management policy rules are rules that reflect organizational policy. For example, the management policy rules can define how object network data structures are constructed (e.g., by limiting what objects can be neighbors in a network data structure, or by defining types of social links that should be included as links in the network data structure). For example, organizational policy may dictate that for the purposes of discovering information, linkages in the existing social networks should only be applicable for an employee's neighbors who differ from him/her in their organizational hierarchy by up to two levels. When implemented in management policy rules in the policy server (210), this organization policy may be stated in a different but equivalent way to conform to a policy language that is available for use with the policy server. For instance, in an ILM 2, for a given request made to the policy server (210), there are one or more management policy rules, which together state that the proposed request is admissible and which together define the workflows that are triggered as part of processing the request. In a simplified sense, requests to update objects in this implementation can be thought of as the following tuple: [Principal Set, Target Current, Target Final], where a user object in the Principal Set can do an update operation on a resource object in the Target Current set, only if after the modification, it will fall in the Target Final set. The Principal Set may not be the user objects in the network but rather the agent accounts in the system (which can also be user objects) that are allowed to make the changes necessary to build and maintain a network of user objects (for example, administrator agent accounts). In this implementation, each user object can have a multi-valued attribute called “Neighbor”, which is a reference attribute to other user objects. Each user object also can have an “Organization Level” attribute, which indicates the corresponding user's level in the organization. In such an implementation, a management policy rule can have Target Current and Target Final sets, which specify a filter to include in the Neighbor attributes only references to neighbors that do not differ from the referencing user objects on the basis of the Organization Level by more than two. This management policy rule can constrain requests to change the existing network structure of user objects so that user objects can only have neighbors referenced in the Neighbor attributes if the neighbors are above or below them no more than 2 levels in the Organization. Thus, even if a lower level employee is a friend of a company CEO in a social networking database that is used by the policy server (210) in constructing a network data structure, a policy rule may dictate that a user object corresponding to a lower level employee cannot be a neighbor of a user object corresponding to the CEO of a company.

The policy rules can also be used in determining how an object network data structure is used. For example, a policy rule may dictate that resources that are flagged as being extremely confidential can never be discoverable resources. As another example, a policy rule may dictate that resources are generally discoverable if a neighbor user object has access to the resource, or alternatively a policy rule may dictate that resources are generally discoverable if a neighbor user object is an owner of the resource. Accordingly, the policy rules typically may be customized to fit the needs of particular organizations.

The network data structures can be used by the policy server (210) to construct discovery lists, which can indicate resources that particular objects (such as user objects) are allowed to be aware of and to which the objects can request access. For example, resources can be represented as resource objects in a database managed by the policy server (210). A resource object can include discovery attributes that contain the identifiers of user objects associated with users who can discover the resource, and access attributes that contain identifiers of user objects associated with users who can access the resource. Policy rules can restrict the list of resource objects that can have non-empty discovery attributes and the list of user objects that can be added as eligible for discovery, and to what resources, all based on a particular organization's policy. As will be discussed more below, those discovery lists can be used to determine what inaccessible resources can be suggested to users so that the users can have options to request access to the resources (such as by clicking on the suggestions).

B. The Synchronization Engine and Relationship Databases

Referring still to FIG. 2, the policy server (210) can interact with a synchronization engine (215). For example, the synchronization engine (215) can be a module that is part of ILM 2. The synchronization engine (215) can synchronize multiple computer databases, and thereby conduct data flow between a database in the policy server (210) and other databases in the system (200), such as relationship databases (220). The synchronization engine (215) can synchronize such databases on a periodic basis or some other basis so that the databases in the policy server (210) and elsewhere are sufficiently up-to-date. Data flow rules specifying how data flows between different databases under the control of the synchronization engine (215) can be specified, such as using management agents. For example, data flow rules can dictate which data source or database is authoritative for a particular type of data (e.g., name, email address, telephone number, and group membership). There can be different management agents associated with different modules or databases (e.g., a search engine management agent, a SharePoint® site database management agent, etc.).

The relationship databases (220) can be standard databases that define relationships between objects, and those relationships can be used by the policy server (210) to define the network data structures. For example, the relationship databases (220) can include a Microsoft Exchange database (222), a social networking database (224), and a Microsoft Office Communicator database (226). The synchronization engine (215) can synchronize relationship data (228) to, from, and between all those databases during the synchronization. The synchronization engine (215) can also flow the relationship data (228) into and out of a database that is used by the policy server (210). Thus, the database for the policy server (210) can include updated information about relationships that are represented in the databases (220), and this information can be used in constructing and updating network data structures.

The synchronization engine (215) can also interact with resource databases (230) to synchronize access control information. The resource databases (230) can store any of a variety of computer resources. For example, the resource databases (230) can include a database (232) storing Network File System (NFS) folders as resources, a database (234) storing generic data as resources, a database (236) storing Microsoft Exchange distribution lists (DLs) as resources, and a database (238) storing Microsoft SharePoint® sites as resources. The synchronization engine (215) can flow to the resource databases (230) updates (240) to data and access permissions for resources in those databases, which updates (240) can be dictated by the policy rules of the policy server (210). For example, this can include synchronizing the resource databases (230) with a policy server database, and having the policy server database be considered by the synchronization engine (215) to be the authoritative version of the data being synchronized.

The synchronization engine (215) can also interact with a search engine (244). Specifically, access control lists (246) for the resources in the resource databases (230) can flow from the search engine (244) (typically from a database utilized by the search engine (244)) and to the policy server (210) (typically to a database utilized by the policy server (210)). In addition, updated access control lists (248) with discovery lists can flow back from the policy server (210) to the search engine (244).

Accordingly, the synchronization engine (215) is able to flow information between the policy server (210) and other components, such as the search engine (244), which is typically done by flowing information between databases utilized by those components. However, data could flow in some other manner, such as by being passed in messages (API calls, HTML messages, etc.) between various components.

C. Search Facilities

The search engine (244) can crawl the resource databases (230) to obtain and update search index information corresponding to the resources in the resource databases (230). Such information can include location information for linking to the resources, keyword information, and information regarding tags associated with the resources. Those tags can include access control information. Using that crawl information, the search engine (244) can access and update an index database (252), which can include indices corresponding to the resources in the resource databases (230). The indices can include information such as location information for the resources, titles for the resources, etc. Additionally, the index database (252) can include access control and discoverability tags, which can indicate whether particular resources are accessible by specific objects and/or whether particular resources are discoverable by specific objects. For example, the tags may indicate that a certain user object cannot access a certain NFS folder, but that the user object can discover that NFS folder. In that case, if the NFS folder is responsive to a search request entered by a user corresponding to that user object, then the user cannot access the NFS folder at that time, but the user can be made aware of the folder and can request access to the folder. The index database (252) can be updated as the synchronization engine (215) flows updated access control lists (248) with discovery lists from the policy server (210).

For each resource, or only for those resources that may be discoverable, the index database (252) can include linking information for triggering an approval process for requesting access to the resource (e.g., a script for sending an appropriate email, information for sending a web service call, or information for sending an API call to the policy server (210) to invoke a custom workflow).

The search facilities can also include a search user client (254), which can receive user input, such as a search request (256). The search user client (254) can pass the search request (256) on to a search portal (260). The search portal (260) can in turn pass a corresponding query (262) on to the search engine (244). A search engine is a module that conducts a search and generates search results, while a search portal is a module that interacts (directly or indirectly) with one or more user input and output devices and with a search engine to receive requested searches from user input and to present search results received from the search engine. The search engine (244) and search portal (260) can be modules in a single software product, such as Microsoft Office SharePoint® Server 2007. Alternatively, the search engine (244) and search portal (260) can be search features of some other product where the search engine is able to serve results from restricted resources and handle indications of discoverable resources, such as many existing enterprise search solutions.

Upon receiving the query (262), the search engine (244) can conduct a search by running a standard search algorithm on the indices in the index database (252), and can produce search results from the search. The search results can include representations of the responsive resources, such as a tuple corresponding to each responsive resource. The search engine (244) can filter from the results those resources that are inaccessible to a corresponding search initiation object (such as the user object corresponding to the user who initiated the search). As used herein, filtering the results can include not including specified representations in the results at all, and/or removing specified representations from the results. In addition, the search engine (244) can include in the results suggestions for inaccessible but discoverable resources that are responsive to the query (262).

The search results can also include one or more identifiers that distinguish between the suggestions for inaccessible resources and the representations of accessible resources. Such identifiers can include any indication that can distinguish between the suggestions for inaccessible resources and the representations for accessible resources. For example, the identifier(s) could include a tag that corresponds to the entire set of suggestions for inaccessible resources and/or the entire set of representations of accessible resources, a tag corresponding to each suggestion for an inaccessible resources and/or each representation of an accessible resource, or even an ordering or format of the representations and/or suggestions.

The search results (264), including the main results for accessible resources and the suggestions for discoverable resources, can be sent from the search engine back to the search portal (260). The search engine may place certain limitations on the suggestions. For example, the amount of information included in the suggestions may be less than the amount of information included in the representations of the main results. This can prevent the suggestions from revealing too much information.

The search portal (260) can return the results (266) to be displayed on a computer display or otherwise presented to a user at the search user client (254). A user can then select representations of the main (accessible) search results to access the corresponding resources from the resource databases (230). In addition, if a user selects a suggestion of an inaccessible but discoverable resource (such as by clicking on a corresponding link in a standard way), then the search portal can send a request (270) for access to the discoverable resource to the policy server (210). The request (270) can be in any of various formats that can be received by the policy server (210), such as an email message, an API call, or an HTTP message. Alternatively, an access request may be sent to a destination other than the policy server, such as being sent directly to an owner client (272).

Upon receiving the request (270), the policy server (210) can trigger an approval process for requesting and obtaining access to the corresponding resource. For example, the process can be defined by a workflow, as discussed above, and the policy server (210) can trigger the workflow. The approval process may include sending an access request message (274) to the owner client (272) (possibly after performing additional actions such as requesting additional information from the search user or others), which can display a representation of the request message (274) to a user corresponding to a user object that is designated as the owner of the corresponding resource.

The request (270) may include information that can be used in the approval process, such as a name or some other indication of who owns the resource. In some situations, the request (270) may not include such information, such as where the information is not available to the search engine (244). In that case, such information can be brought into the policy server (210) by using a specific management agent that can be used by the synchronization engine (215) to fetch the relevant information directly from a corresponding database of the resource databases (230). For example, the search engine (244) may be able to index SharePoint® sites from the database (238) storing SharePoint® sites as resources, but the search engine (244) may not be capable of determining to whom a request for access should be sent for each SharePoint® site. In this case, the synchronization engine (215) can fetch this information directly from the database (238) storing SharePoint® sites as resources using a SharePoint® management agent, and can bring the information into the policy server (210). In the policy server (210), the information can be associated with SharePoint® site information. For example, the SharePoint® site information can be information that is brought to the policy server (210) from the search engine (244) using a search engine management agent.

The owner client (272) can receive user input from the owner and can send a corresponding response message (276) to the policy server (210). If the response message (276) is a rejection of the request message (274) or if the approval process otherwise fails, then the object corresponding to the search user will not gain access to the corresponding resource. However, if the approval process succeeds, such as if the response message (276) indicates approval, then the policy server (210) can update its access control lists to indicate that the object has access to the corresponding resource. The synchronization engine (215) can then flow that access indication to the corresponding database of the resource databases (230), and it can be updated in the index database (252) the next time the search engine (244) crawls the corresponding database.

Accordingly, when conducting a search, a user can be made aware of appropriate resources within the scope of the search, even if those resources are not currently accessible to a user object corresponding to the user. This approach can also be useful when users are seeking to find resources in other ways, such as viewing directories or folders of resources. For example, in the case of a user viewing directories or folders, representations of inaccessible resources may be generally hidden from view, but suggestions could be presented to the user if the resources are inaccessible but discoverable. In that case, the module that manages the folders or directories could interact similarly to the search engine (244) discussed herein with reference to FIG. 2. As another example, as discussed above, a push model can be implemented, where a user signs up for an aggregation service and receives an aggregated feed or email with the results. In such an implementation, the user input requesting the search can be user input requesting that a user or user object be subscribed to the aggregation service that uses one or more search criteria for composing the aggregation.

The different computing environments and modules illustrated in FIG. 2 may be different computing environments or modules, or they may be different aspects of the same computing environments or modules. For example, an administrator client (204) may be the same computing environment as the owner client (272), or they may be different computing environments.

In one implementation of the system (200) discussed above, the policy server (210) and the synchronization engine (215) can be modules of ILM 2, and the search engine (244) and the search portal (260) can be search modules that are part of Microsoft Office SharePoint® Server 2007. The modules of Microsoft Office SharePoint® Server 2007 can be modified to display the suggestions in addition displaying the main results. In addition, with regard to ILM 2, some schemas can be modified to operate as discussed above (e.g., to store the types of data objects discussed above), one or more custom workflows can be written as discussed above, and management policy rules such as those discussed above can be expressed using standard facilities that are already present in ILM 2.

III. Example of a Search Portal Display with Discoverable Resource Suggestions

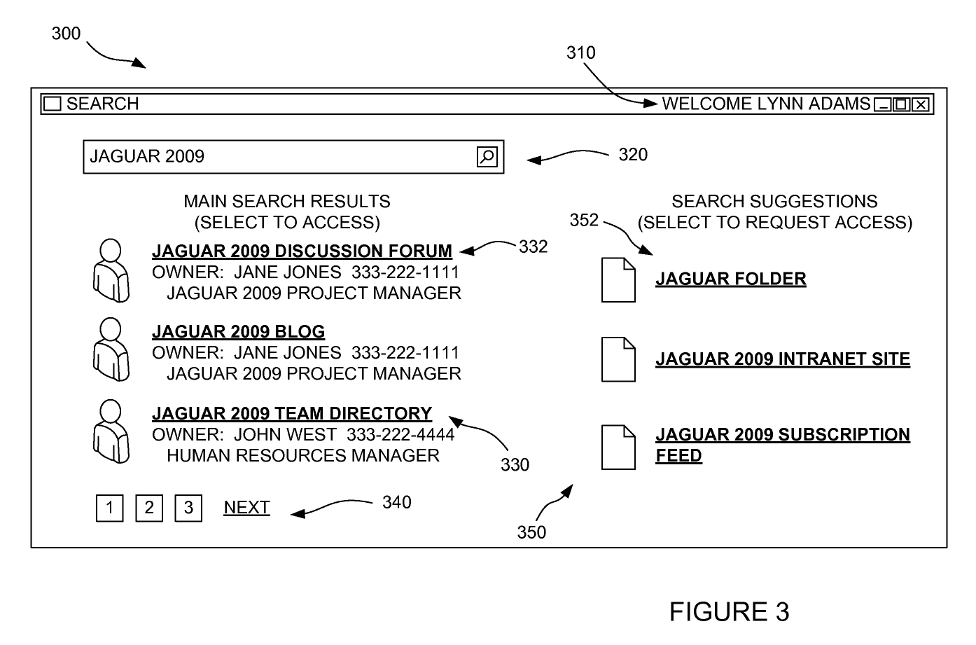

Referring now to FIG. 3, a search portal display area (300) is shown displaying search results. The display area can include an object indication (310), which indicates the object corresponding to the search. In the illustrated example, the object indication (310) indicates that the object is a user object corresponding Lynn Adams, a user. For example, the user may be logged into a user account that is associated with the user object.

The display area (300) can also include a search entry line (320), which can display search terms entered by the user, and where a user can click to enter or revise search terms in a standard manner. The display area (300) can also include representations (330) of accessible resources from the main search results. Each of the representations (330) can include a trigger area (332), where a user can click to select the representation (330), such as by performing a mouse click while a mouse pointer is hovering over the trigger area (332). When a representation (330) is selected, the corresponding resource can be accessed, such as by displaying a corresponding folder or document.

The display area (300) can also include standard navigation buttons or target areas (340), which can be selected to navigate between different pages of search results.

The display area can also include suggestions (350) as part of the search results display. The suggestions (350) can be representations of inaccessible but discoverable resources. Each suggestion (350) can include a trigger area (352), which can be selected similarly to the trigger areas (332). However, when a trigger area (352) for a suggestion (350) is selected, an approval process can be triggered so that access to the corresponding resource can be requested for the corresponding object, such as a user object.

The suggestions (350) may include fewer types of display information (i.e., information to be displayed to a user) than the representations (330) of the main accessible search results. This can be done to keep too much confidential information from being shared with unauthorized users. For example, the illustrated representations (330) may include information about the owners of the resources, while the suggestions (350) may not include such information.

Of course, many alternative display configurations are possible, and the display area of FIG. 3 is provided as just one example.

### IV. Techniques for Discovery of Inaccessible Computer Resources

Techniques for discovering inaccessible resources will now be described. These techniques may be implemented with the computer systems and environments discussed above, or with other computer systems and environments.

A. Technique for Identifying Accessible and Discoverable Resources

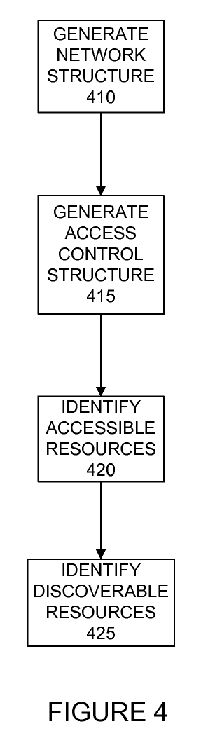

Referring to FIG. 4, an example of an inaccessible computer resource discovery technique will be described. In the technique, an object network data structure is generated (410). For example, this may be a structure linking user objects based on social connections between the corresponding users, as indicated by one or more databases (social networking database, Microsoft Exchange database, etc.). An access control structure, such as an access control list indicating access rights for objects to particular computing resources, can also be generated (415). Resources that are accessible by an object, such as a user object, can then be identified (420) using the access control structure. In addition to the accessible resources, discoverable resources can also be identified (425) using the network data structure.

For example, a search can be performed to identify a set of resources that are responsive to the search. The results of the search, which may be in the form of representations of the set of resources, can be filtered according to the access control structure to identify a sub-set of accessible resources of the set of resources. The set of resources can also be filtered according to the network data structure to identify a sub-set of inaccessible but discoverable resources of the set of resources. For example, this can be done by applying a set of policy rules to the network data structure and to the set of resources. For example, the policy rules may dictate that resources are considered discoverable if the resources are owned by a user object that is directly connected to the object associated with the search in the network data structure. The policy rules may also place other limitations on the discoverability, such as limiting it to user objects that are in a particular department, etc.

Once the accessible and discoverable resources are identified, they may be used in various ways, such as returning the sub-sets of accessible and discoverable resources as search results, and displaying those results on a computer display.

B. Producing Search Results with Discoverable Resource Suggestions

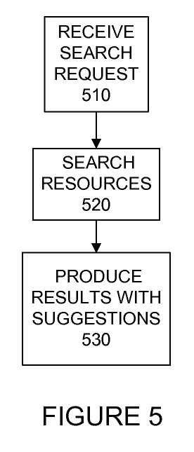

Referring now to FIG. 5, a technique for producing search results with discoverable resource suggestions will be described.

A request for a search of computer resources can be received (510), such as at a search engine. In response to receiving the request, available resources can be searched (520) to identify resources that are responsive to the search request. For example, this may include querying one or more index databases, where the databases include indices representing available resources. Results can then be produced (530), and the results can include suggestions of resources that are inaccessible but discoverable. For example, an object associated with the search may not have access rights to such resources, but may have rights or permission to be made aware of the resources and request access to them.

C. Displaying Search Results with Inaccessible Resources

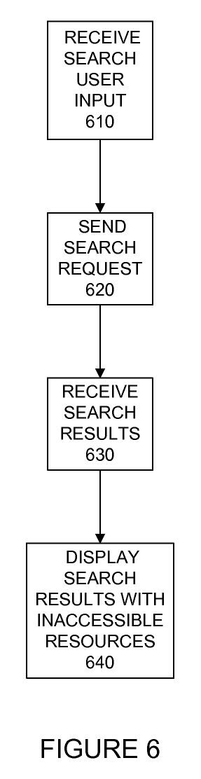

Referring to FIG. 6, a technique for displaying search results with inaccessible resources will be described. Search user input can be received (610), such as receiving a user-input request for a search of computer resources at a search portal. A search request corresponding to the user input can be sent (620), such as a search request or query being sent from a search portal to a search engine. Search results corresponding to the request can be received (630). For example, the results can be received by a search portal from a search engine. The search results can be displayed (640). The displayed results can include inaccessible resources, such as resources to which an object associated with the search request does not currently have access. However, the inaccessible resources may include discoverable resources to which the object associated with the search request has permission to request access.

D. Discovering and Requesting Access to Inaccessible Resources

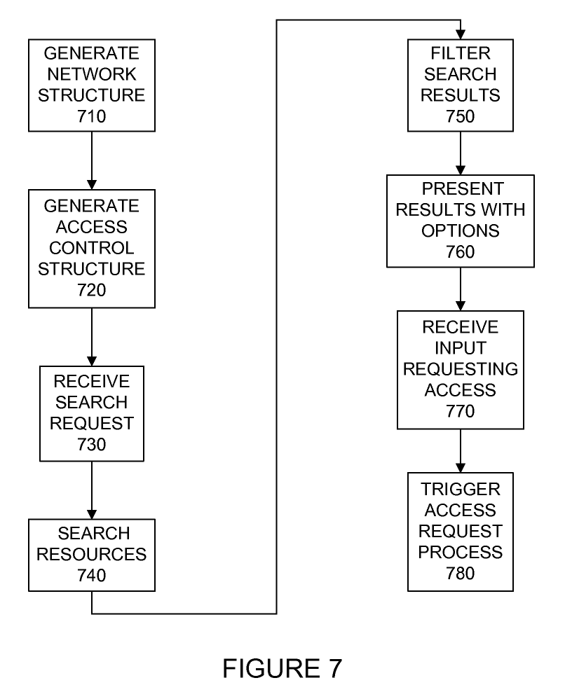

Referring now to FIG. 7, a technique for discovering and requesting access to inaccessible resources will be described. In the technique, a network data structure can be generated (710), and an access control structure can be generated (720). A request for a search of resources can be received (730), and available resources can be searched (740). Results of the search can be filtered (750), such as being filtered so that the results only include representations of discoverable and accessible resources. The results, along with options to access the accessible resources and to request access to the discoverable resources, can be presented (760) to a user. For example, an option may include a target display area that can be selected by a user to access a corresponding accessible resource or to request access to a corresponding discoverable resource.

Input requesting access to a discoverable resource can be received (770), and receiving the user input can trigger (780) an access request process, such as by triggering a workflow that defines an access request process.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A computer-implemented method, comprising:
receiving at a search portal user input from an input device, the input associated with a user object and requesting a search of resources in one or more computer databases;
sending a request to a search engine to perform the search;
receiving search results from the search engine in response to the request; and
displaying on a computer display at least a portion of the search results from the search of the resources, the displayed search results including one or more representations of one or more resources to which the user object currently has access, and one or more representations of one or more resources to which the user object does not currently have access.

2. The method of claim 1, wherein the user input comprises a request to subscribe to an aggregation service.

3. The method of claim 1, further comprising receiving user input requesting access to a requested resource to which the user object does not currently have access.

4. The method of claim 3, further comprising, in response to receiving the user input requesting access, triggering an access request process.

5. The method of claim 4, wherein triggering the access request process comprises invoking a workflow that defines the access request process.

6. The method of claim 1, further comprising filtering from the search results representations of one or more resources to which the user object currently has neither access nor permission to request access.

7. The method of claim 1, wherein the one or more representations of one or more resources to which the user object currently has access include more types of display information than the one or more representations of one or more resources to which the user object does not currently have access.

8. The method of claim 1, wherein the one or more representations of one or more resources to which the user object does not currently have access are displayed as suggestions of resources to which access can be requested for the user object.

9. A computer system comprising:
means for generating a network data structure;
means for generating an access control data structure indicating user access permissions to a set of computer resources;
means for using the access control data structure to identify one or more accessible computer resources of the set of computer resources, the one or more accessible computer resources being one or more resources to which an object has access; and
means for using the network data structure to identify one or more discoverable computer resources of the set of computer resources, the discoverable computer resources being resources to which the object does not have access but to which the object can request access.

10. The computer system of claim 9, wherein the means for using the network data structure to identify one or more discoverable computer resources comprises means for applying one or more policy rules to the network data structure to produce one or more discovery lists.

11. The computer system of claim 9, wherein the object is a user object associated with a user.

12. The computer system of claim 9, further comprising means for presenting to a user associated with the object one or more options to access the one or more accessible computer resources.

13. The computer system of claim 9, further comprising means for presenting to a user associated with the object one or more options to request access to the discoverable computer resources.

14. The computer system of claim 9, wherein the set of computer resources is defined by a search of one or more computer resource databases, the search being a user-defined search associated with the object.

15. The computer system of claim 9, further comprising means for searching one or more computer resource databases to define the set of computer resources.

16. The computer system of claim 9, wherein the object is a user object associated with a user, the network data structure represents a network of objects including the user object, and wherein the method further comprises:
means for searching one or more computer resource databases to define the set of computer resources;
means for presenting to a user associated with the user object one or more options to access the one or more accessible computer resources; and
means for presenting to the user associated with the user object one or more options to request access to the discoverable computer resources.

17. One or more computer-readable storage media having computer-executable instructions embodied thereon that, when executed, perform acts comprising:
receiving at a search engine a request for a search of computer resources;
conducting the search of the resources; and
producing search results, the search results comprising:
an accessible resources set comprising one or more representations of one or more resources to which an object associated with the request has access;
a discoverable resources set comprising one or more representations of one or more resources to which the object does not have access but does have permission to request access; and
a set of one or more identifiers that distinguish between the accessible resources set and the discoverable resources set.

18. The one or more computer-readable media of claim 17, wherein the object is a user object associated with one or more users.

19. The one or more computer-readable media of claim 17, wherein the acts further comprise returning the results from the search engine to a search portal.

20. The one or more computer-readable media of claim 17, wherein producing the search results comprises filtering the search results to exclude one or more representations of one or more resources to which the object has neither access nor permission to request access.
